(19) United States
(12) Patent Application Publication
(10) Pub. No.: US 2026/0008176 A1
(43) Pub. Date: Jan. 8, 2026

(54) SPIRo: An AI Based Origami Inspired Pneumatic Soft Robot with Multidimensional Locomotion and Multimodal Deep Feature Selection and Fusion with an Improved Deep Forest Classifier Architecture for Real-Time Gas Pipeline Leak Detection

(71) Applicants: Eddie Ruixuan Zhang, Saratoga, CA (US); Evan Ruichen Zhang, Saratoga, CA (US)

(72) Inventors: Eddie Ruixuan Zhang, Saratoga, CA (US); Evan Ruichen Zhang, Saratoga, CA (US)

(21) Appl. No.: 19/274,609

(22) Filed: Jul. 20, 2025

Related U.S. Application Data
(60) Provisional application No. 63/737,766, filed on Dec. 22, 2024.

(51) Int. Cl. B25J 9/10; B25J 9/06; B25J 9/16

(52) U.S. Cl. CPC B25J 9/1075; B25J 9/065; B25J 9/163; B25J 9/1697

(57) ABSTRACT

A soft pipe crawling robot for the inspection of gas distribution pipelines is designed and implemented. It does so using a compliant scissor linkage, McKibben artificial muscle actuators, and magnetic grippers. It can crawl on a horizontal surface and climb up a vertical surface. A two-fold deep feature selection process identifies the most optimal deep features, which are extracted from different subsets of layers in different CNN architectures. A new performance metric, defined as the ASCI, is introduced to gauge the tradeoff between accuracy and model size for deployment on real-time embedded target, An improved deep forest classifier with a more diverse set of estimators is proposed, demonstrating improved performance over other ensemble learning methods. The results demonstrate the robustness of the system achieving high accuracy at a relatively small model size.

### BACKGROUND

Natural gas is becoming increasingly prevalent in the world's energy usage, with most of it being transported through pipelines. However, statistics reveal that pipeline leaks are alarmingly frequent with many smaller leaks going unnoticed. These failures result in billions of dollars in damage, severe environmental contamination, and sometimes even loss of life. Furthermore, pipeline leaks release millions of tons of methane annually. Methane is 30 times more potent than carbon dioxide and accounts for a third of the world's warming due to greenhouse emissions. Therefore, early detection of gas infrastructure leaks is an efficient and effective way to reduce emissions.

Current industrial gas leak detection methods, such as hydrostatic testing and camera inspection, are often unreliable, inaccurate, costly, and labor-intensive. Detecting pipeline leaks presents many challenges, primarily due to the harsh and difficult-to-access environments in which upstream pipelines are located. This makes it difficult for traditional rigid pipe inspection robots and humans to locate potential leaks. Additionally, pipeline systems themselves are inherently complex, often consisting of bundles of pipes of varying diameters and sizes. External conditions, such as weather, also significantly affect gas leak detection, making autonomous detection even more challenging. As a result, there is an urgent need for a reliable system capable of inspecting gas leaks in real-time with high accuracy.

### SUMMARY OF THE INVENTION

SPIRo (Soft Pipe Inspection Robot) is a pneumatically soft robotic solution to enhance gas leak detection through multidimensional locomotion for adaptability to varying environments and high load bearing capability. The robot uses a compliant scissor linkage for structure, McKibben artificial muscle actuators for locomotion, and magnetic, pouch motor-based grippers to attach to piping. The flexible body enables large deformations to traverse over obstacles and transition between pipeline orientations. In testing, the robot achieves a speed of 15 mm/s when crawling horizontally and 9 mm/s when climbing vertically with a payload of equipment sufficient to support leak detection. A thermal sensor and two gas sensors are attached to SPIRo for real-time gas composition data and thermal imaging data collection.

For the multimodal data collected, we implemented a multimodal deep feature selection and fusion method with an improved deep forest architecture for real-time leak detection. Deep features of thermal images from different layers of Convolutional Neural Network (CNN) architectures were visualized using Gradient-weighted Class Activation Mapping (Grad-CAM). Optimal sublayers are selected based on feature visualization and empirical knowledge. The Improved Deep Forest Classifier (IDFC) including Completely Random Forest (CRF), Adaptive Boosting (Adaboost), eXtreme Gradient Boosting (XGBoost), and Mondrian Forest (MF) is proposed to improve accuracy and efficiency through a diverse set of estimators. To understand the trade-off between the model size and accuracy, we propose the Accuracy Size Comprehensive Indicator (ASCI) to facilitate the secondary selection of multimodal features in real-time systems with limited resources. Guided by ASCI, the final CNN combination consists of the first three blocks of the Residual Network-50, the first twelve layers of the Visual Geometry Group (VGG) Net, and the first seven blocks of the EfficientNet. On the simulated testing dataset, this combination, along with the IDFC and gas sensor data, achieves an accuracy of 0.989 for leak detection. This lightweight Artificial Intelligence (AI) architecture is deployed successfully on the soft robotic system (SPIRo) for real-time gas leak detection. SPIRO system introduces an efficient platform for infrastructure inspection in a wide array of applications.

### DRAWINGS

FIG. 1: System design overview.
(A) An overview of the full design drawn using Computer Aided Design (CAD). It includes the full assembly with the compliant scissor linkage, magnetic grippers, actuators, and sensors and camera.
(B) Detailed depiction of the scissor linkage design and assembly.
(C) CAD model of the origami inspired pouch motor and magnetic gripper.

FIG. 2: SPIRo Robotic System on a 5-inch diameter gas pipe.
(A) The SPIRo front view with its thermal imaging camera.
(B) The SPIRo rear view with its MQ2 and MQ7 gas sensors.

FIG. 3: SPIRo sensor connections with the MyRIO Controller and Machine Learning Model flow.

FIG. 4: Pneumatic Control using a MOSFET control circuit and pneumatic valves. It is controlled using LabVIEW and a MyRIO microcontroller.

FIG. 5: Algorithm Framework.

FIG. 6: IDFC Architecture.

FIG. 7: Final architecture of proposed gas leak detection model

FIG. 8: Control Circuit Diagram for Pneumatic Valve for Individual Actuation of SPIRo.

FIG. 9: The timing diagram utilized to control the inflation and deflation of each system. The state of the actuators and scissor mechanism corresponds with the numbered markings on the timing diagram. Parts of the robot that are shaded completely are inflated.

FIG. 10: SPIRo processes:
(A) SPIRo deforms vertically upwards through actuation of the bottom extensional actuators.
(B) SPIRo deforms vertically downwards through actuation of bottom extensional actuators.
(C) SPRIo utilizes vertical deformation to transition between a horizontal and vertical surface.

FIG. 11: Certain processes:
(A) Transitioning from a horizontal to a vertical surface.
(B) Turning left to adapt to a bend in piping.

FIG. 12: Flexible body:
(A) Graph of the deformation of the body over time as measured in degrees. The color of the lines corresponds with the caption of each image below.
(B) Bending of the body in 4 directions: Upwards, Downwards, Left, and Right.

FIG. 13: Extension distance of extensional actuator at 10 PSI.

FIG. 14: The design of the McKibben muscle actuator. The nylon cover is represented by the cross pattern over the latex tubing.

FIG. 15: The extension of the McKibben muscle in relation to PSI. The muscle experiences rapid growth between 10 and 20 PSI. Length change is measured by a camera positioned above the actuator.

FIG. 16: Origami inspired design:
(A) The difference between the origami inspired variant and non-origami inspired variant.
(B) Graph demonstrating the differences in deformation between the 4 variants of pouch motor tested.

FIG. 17: Deformation distance of various dimensions of pouch motor designs at differing PSI.

FIG. 18: Examples of Convolutional Neural Networks.

FIG. 19: Model Weights for Inputs of Deep Forest Learning.

FIG. 20: Thermal images captured by the SPIRo thermal camera.
(A)-(C): with the absence of gas, i.e. no leak,
(D)-(F): minor gas leak,
(G)-(I): major gas leak.

FIG. 21: MQ2 and MQ7 gas sensors reading on the MyRIO Analog Input ports

FIG. 22: Diagram of a pneumatically soft robotic device to detect gas leak from a pipeline.

FIG. 23: Flow diagram of a method to detect gas leaks from a pipeline by a pneumatically soft robotic device.

### DETAILED DESCRIPTION

### 1. SPIRo Soft Robot Design and Fabrication

The systems, methods and devices of this disclosure each have several aspects, no single one of which is solely responsible for the desirable attributes disclosed herein.

The following description is directed to certain implementations for the purposes of describing various aspects of this disclosure. However, a person having ordinary skill in the art will readily recognize that the teachings herein can be applied in a multitude of different ways. Some of the concepts and examples provided in this disclosure are especially applicable for soft robots using deep learning to detect gas leaks.

A compact out of pipe design shown in FIG. 1A was selected to allow continuous monitoring of pipelines without interrupting their operation or risking contamination of the pipe's contents. This design also facilitates easier insertion and removal, enhancing the robot's usability in real-world scenarios. A design utilizing the characteristics of soft robots was chosen for the characteristics listed above: namely the maneuverability, compact size, and adaptability. This approach allows the robot to be used in a complex pipeline environment with turns, space constraints, and elevation changes in piping and enables wider adoption due to its adaptability to a wide variety of challenging environments.

The robot's design can be categorized into three primary components: the compliant scissor linkage, the McKibben muscle actuators, and magnetic grippers.

The first component, the compliant scissor linkage, serves as the main structure of the robot and is illustrated in FIG. 1A. A compliant mechanism is a flexible mechanism that achieves force and motion transmission through elastic body deformation. It gains some or all of its motion from the relative flexibility of its members rather than from rigid-body joints alone. A scissors mechanism uses linked, folding supports in a crisscross ‘X’ pattern. The scissor mechanism is a mechanical linkage system used to create vertical motion or extension. It comprises of a series of interconnected, folding supports that resemble the shape of a pair of scissors, hence its name. In one implementation, the compliant scissor linkage extends outwards and contracts inwards under the force of the actuators due to its joints. It is also 3D printed with thermoplastic polyurethane (TPU) filament, which combined with the design of the scissor linkage, allows it to flex under the asymmetric actuation of actuators allowing the robot to turn and maneuver around obstacles. Specifically, the compliant nature of TPU allows the robot to respond to asymmetric actuation forces. The extensional actuators are placed at the top and bottom of the scissors, allowing the entire robot to extend when the actuators are inflated. Each actuator is individually controlled to accomplish steering of the robot. For example, extending only the actuators mounted on the top of the robot bends the entire body downwards. FIG. 1B shows the linkage joints that are designed to minimize resistance by eliminating adhesives and merging components like cross beams into a single flexible part to increase durability. Additionally, the length of the robot is modular, allowing individual linkages to be added or subtracted to allow for larger strides or more compact sizes respectively as required. All tests and data collected in this work were conducted using a length of three linkages as shown in FIGS. 1A and 1B. The scissor linkage also features mounting points on the bottom for grippers which can be interchanged for differing sizes to adapt to different diameter pipes. There are mounting points on the front and rear of the body for sensors, as depicted in FIGS. 1A and 1B. These mounting points allow different types of sensors to be installed for different use cases.

The McKibben muscle inspired extensional actuators are key to locomotion as they are responsible for extending and contracting the robot's body. The muscles comprise of an inflatable inner tube inside a nylon sleeve. When the inner tube is pressurized and expands, the structure acts like a scissor linkage and translates this radial expansion into linear contraction. These surgical tubing McKibben actuators were chosen for their overall compactness and strength, meeting the design requirements outlined previously. They are small but strong enough to achieve high speeds and allow for high maneuverability. Each actuator consists of a latex tube encased in a nylon sleeve, which prevents lateral expansion by constraining the latex to direct force longitudinally. The size of the actuator can be adjusted by varying the length of the nylon sleeve and latex tube, and those sizes are determined by the location of the actuator. When the actuator is inflated, the latex expands, and the nylon tubing will prevent the tubing from expanding outwards laterally instead of forwards. Actuators are mounted on two positions on the robot—horizontally where they expand the body and serve as extensional actuators, and vertically where they contract the body and serve as contractional actuators. These actuators are also soft and bendable, so they can flex with the entire body of the robot, but they are still strong enough to propel the robot at the desired high speeds. Their compact size allows for the dimensions to be within the desired amounts, and their material is highly elastic which allows them to expand and contract rapidly.

For secure attachment to the pipeline surface, the robot is equipped with magnetic grippers or magnetic feet depicted in FIG. 1C. Each gripper comprises a curved frame and an origami-inspired pouch motor that, together, securely adheres the robot to the pipe. The curved frame of the grippers adapts around the curvature of the pipeline to grip to it, and the robot can adapt to varying diameters of piping by replacing the foot to adapt to larger or smaller diameters. These magnetic grippers can be interchanged in a straightforward manner to adapt to a wide array of pipe shapes. The origami inspired pouch motors are responsible for lifting and reengaging the magnets of the foot which allows the attraction between the foot and pipe to be cut off and restarted. When supplied with air, the pouch motors inflate, and this force of inflation pushes the magnets away from the pipe and loosens the force of attraction. When air flow is cut, the pouch motors deflate and the magnets reattract to the pipe. The pouch motors feature an origami inspired design as seen in the side view in FIG. 1C, where the crease of the pouch motor allows the available deformation distance to be increased while the footprint of the pouch motors is kept at a minimum.

FIG. 2 shows a SPIRo Robotic System on a 5-inch diameter gas pipe. FIG. 2A is the SPIRo front view with its thermal imaging camera. FIG. 2B is the SPIRo rear view with its MQ2 and MQ7 gas sensors. FIG. 2 shows the curved magnetic gripper suitable for gripping curved surfaces, as the grippers curve wraps around the pipe being attached to.

### 2. Materials and Components

The body is 3D printed using thermoplastic polyurethane (TPU), which has a shore hardness of 95 A. This allows the body of the robot to maintain stability under the condition that all actuators are extended, but it can also deform with the staggered or independent actuation of actuators. The structure of the feet and mounting frames for the sensors are printed using poly lactic acid, which is more rigid and sturdy. The structure of the feet is 3D printed using poly lactic acid (PLA) filament, which is more sturdy and rigid than TPU.

The McKibben muscle actuators are made with latex tubing with an inner diameter of 4 mm and an outer diameter of 6 mm. A nylon sleeve is slid over the outside of the nylon. It is sealed on one side and attached to the latex pneumatic tubing on the other. A layer of nylon cable guard is used to prevent the surgical tubing from expanding laterally instead of forward by contracting around the tubing as it expands. The pouch motors are made with TPU coated nylon fabric and sealed using an 8 inch impulse heat sealer which makes them airtight. The magnets mounted on the pouch motors are 15 mm diameter neodymium magnets.

### 3. Pneumatic Control

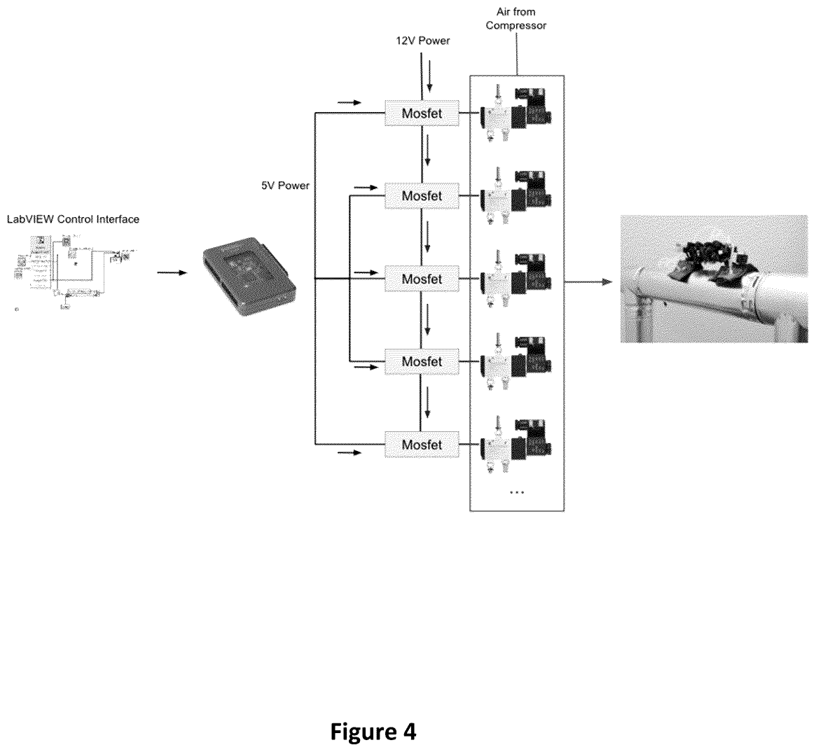

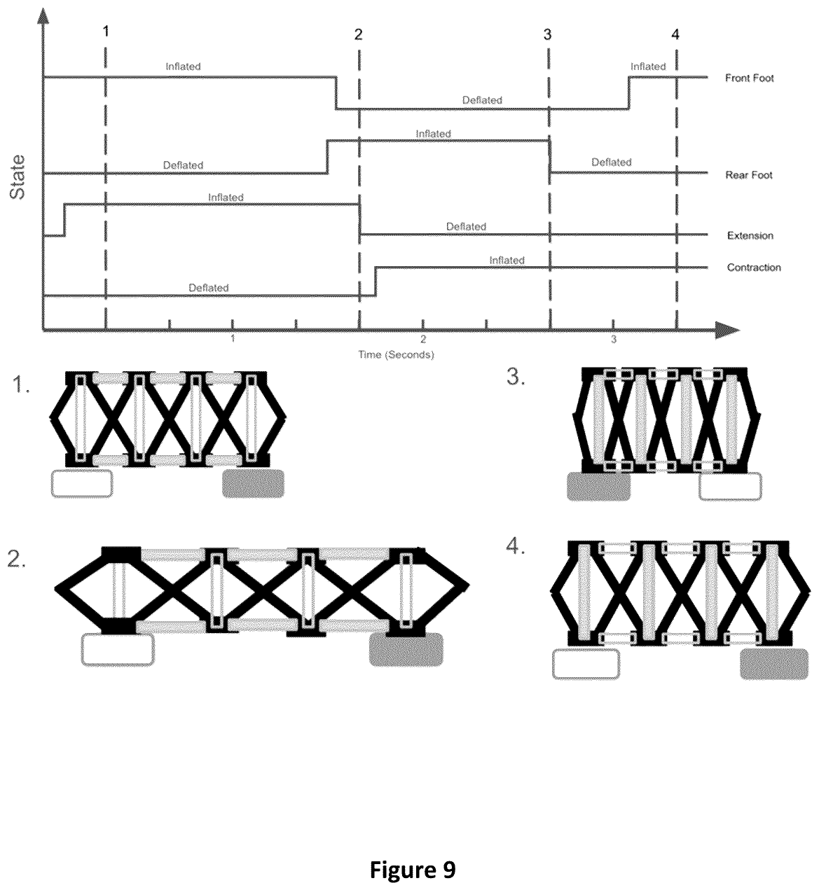

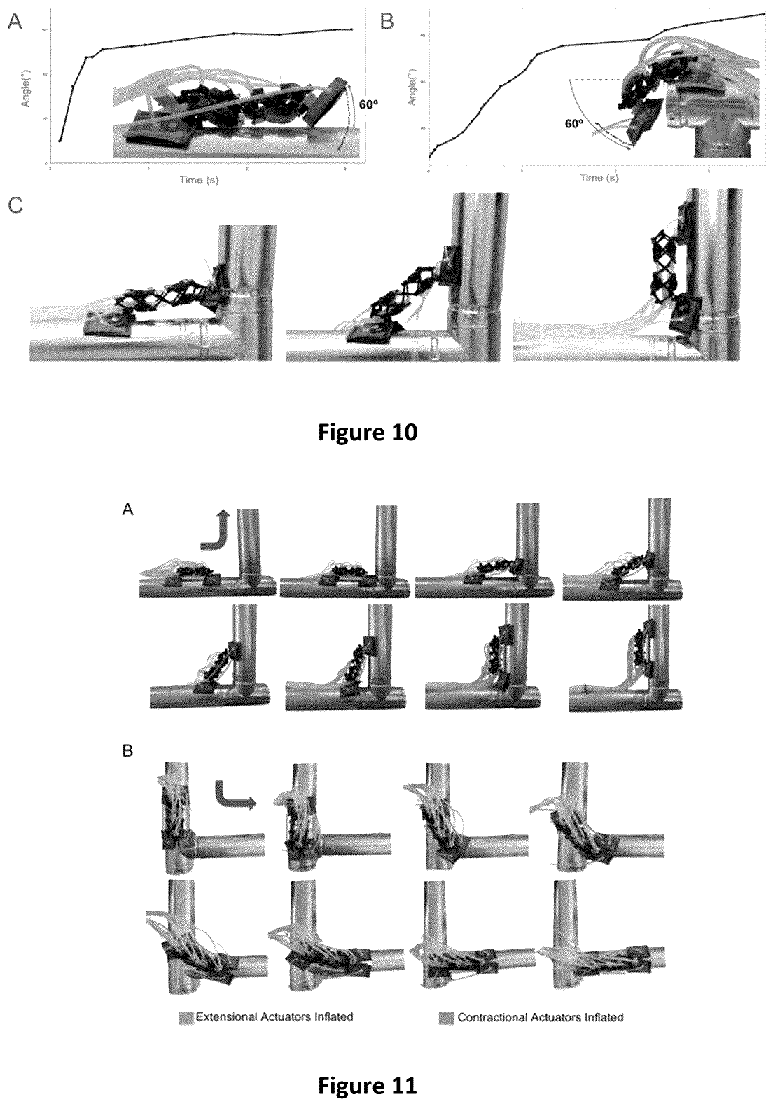

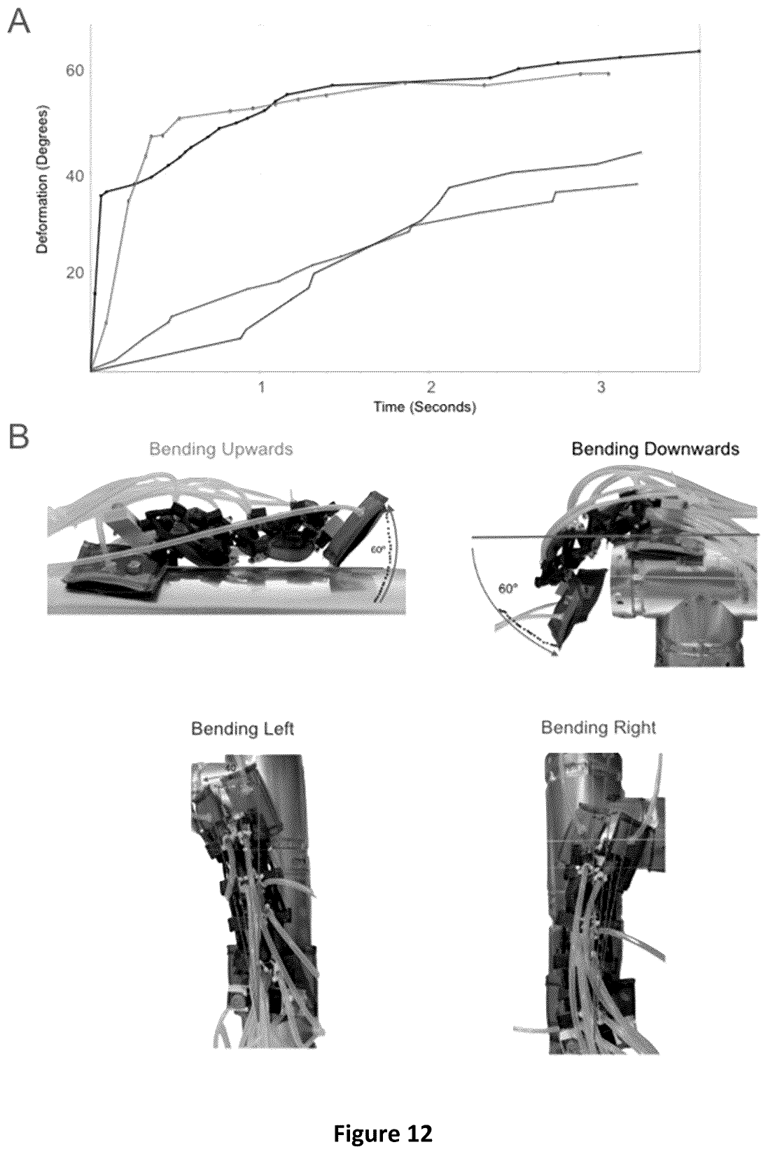

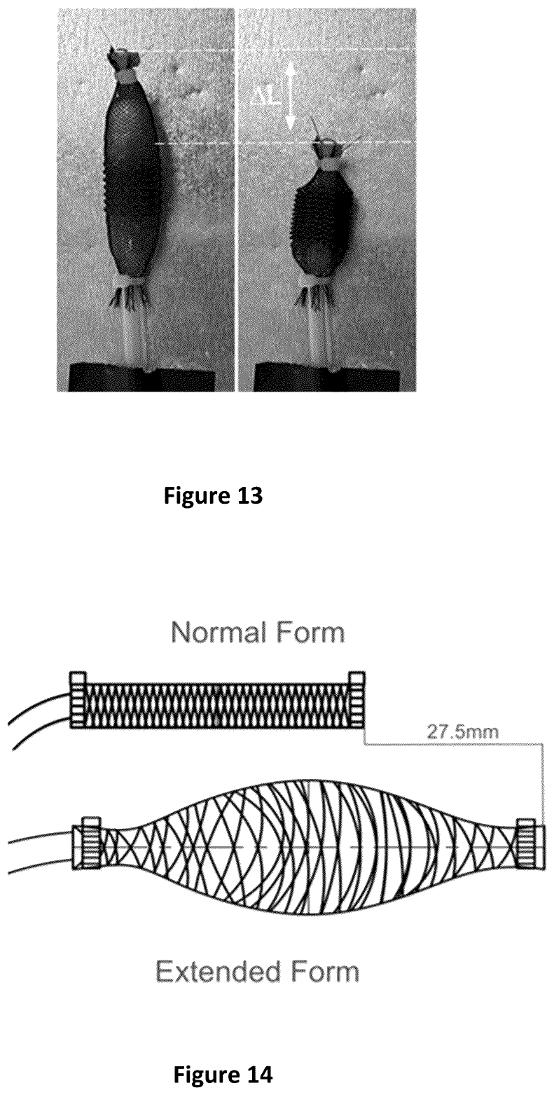

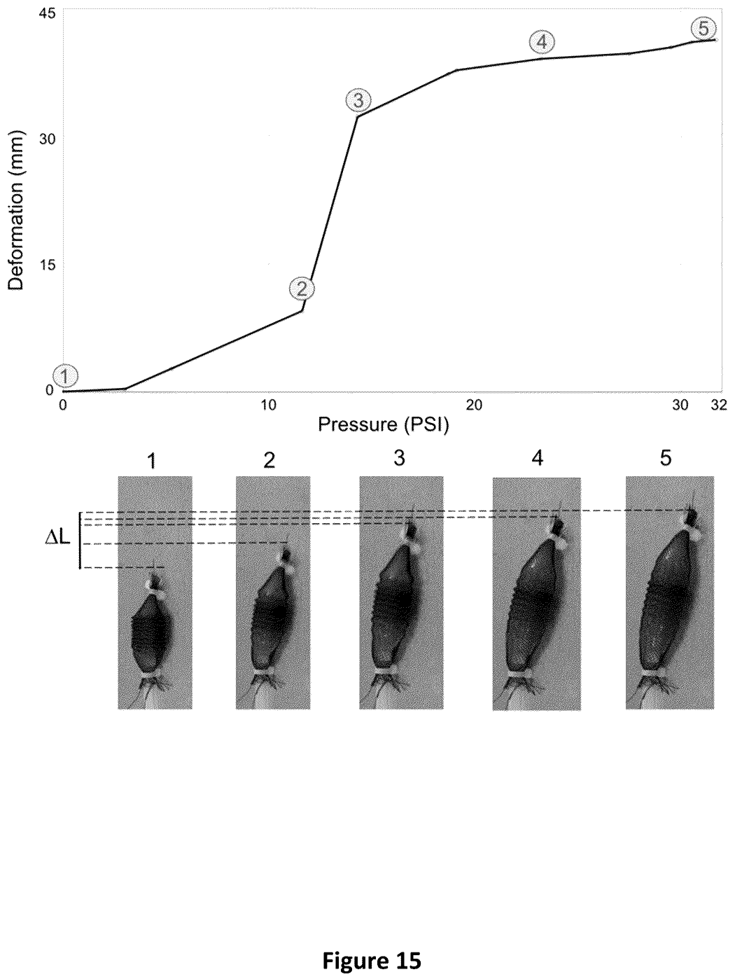

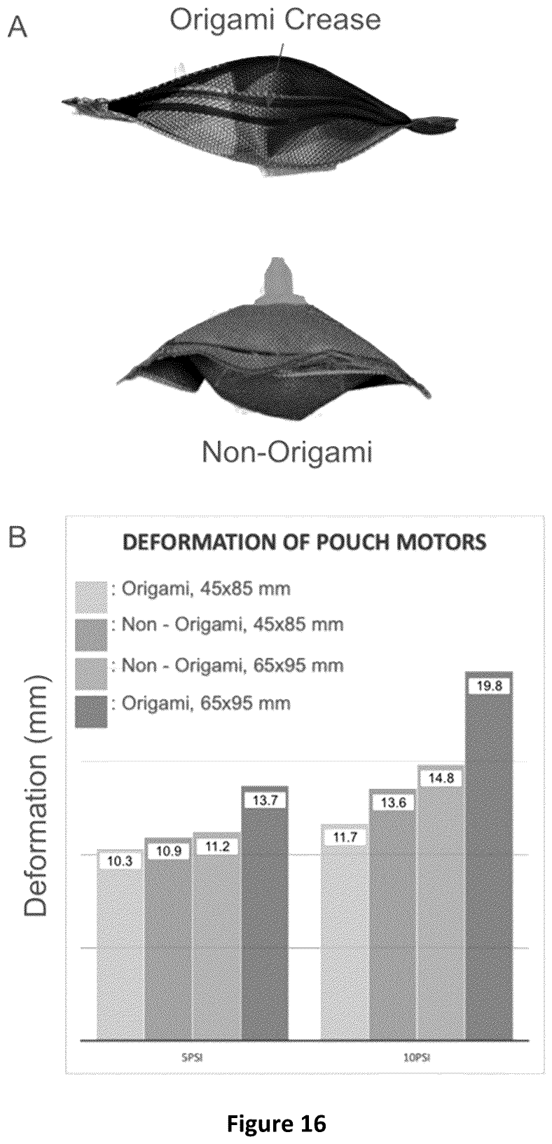

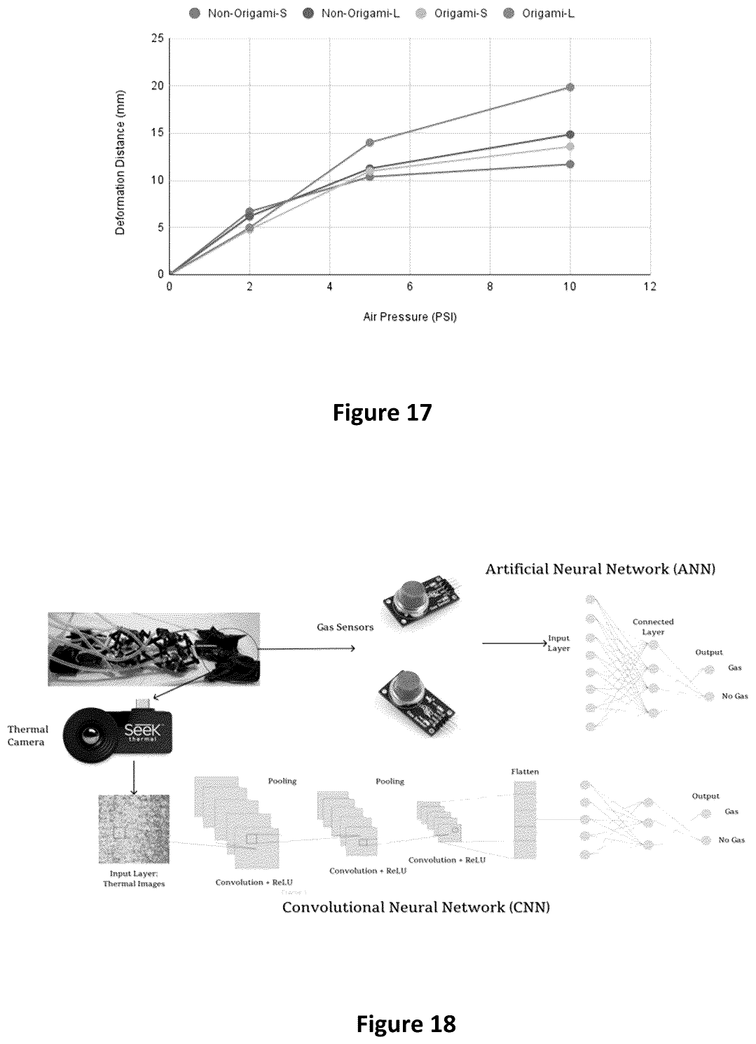

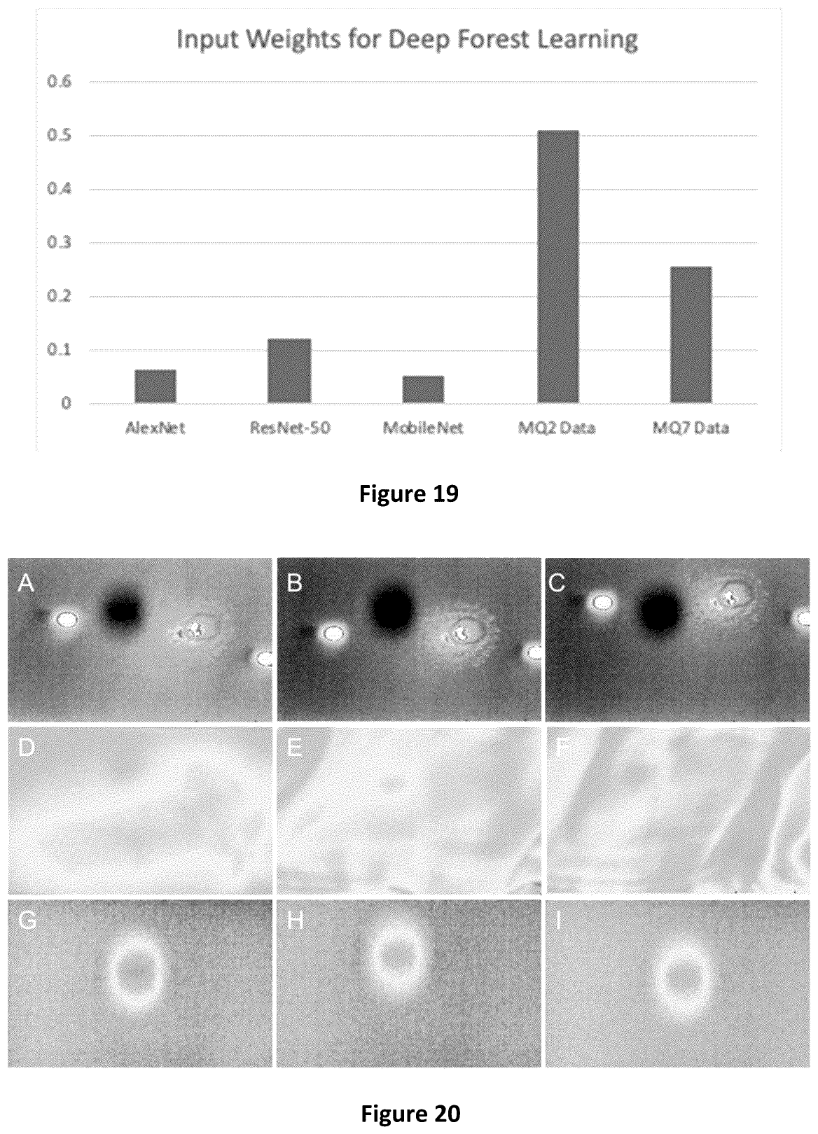

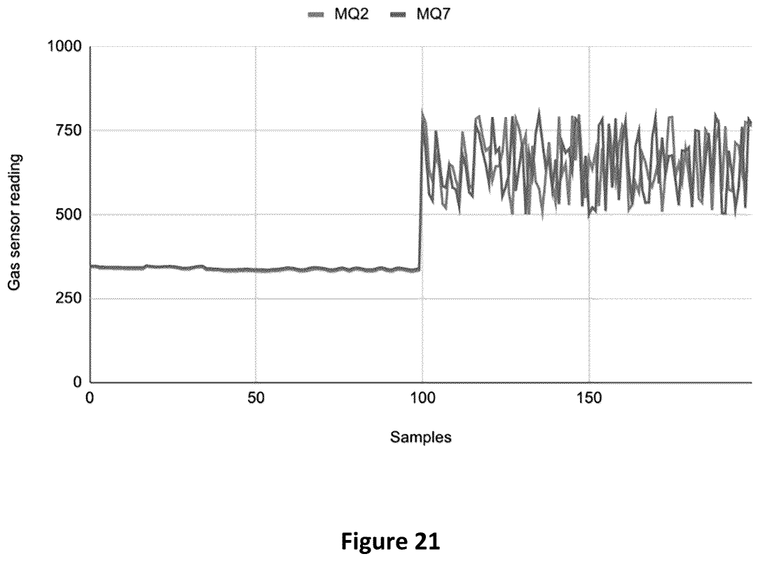

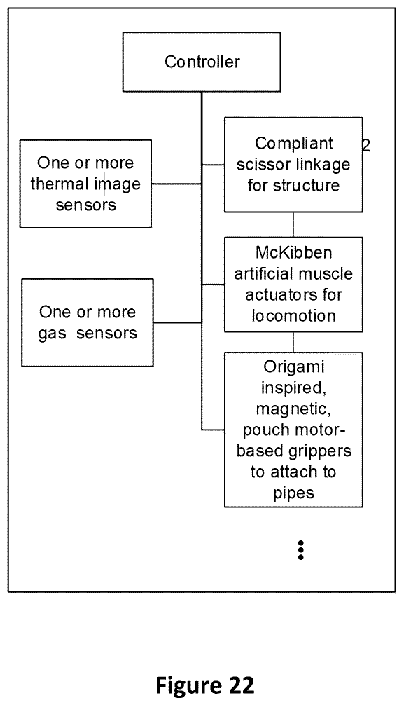

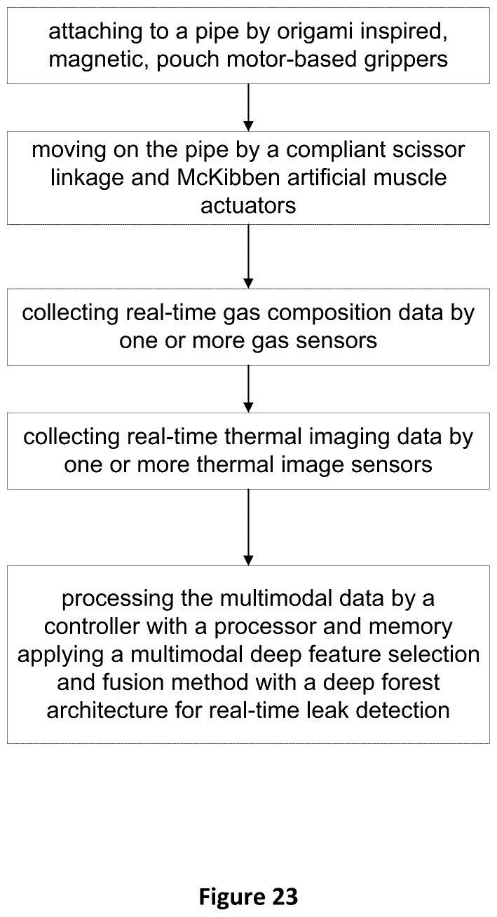

The flow of air to each of the actuators is controlled through a series of eight two-setting pneumatic valves. The setting of the pneumatic valves can be altered using a MOSFET, which controls the voltage to the valves, opening and closing them, as shown in FIG. 4. These MOSFETs are then controlled with the NI MyRIO-1900 microcontroller. The MyRIO features a high memory of 16 MB and higher processing speed 16 mHz than other controllers, making it suitable for SPIRo since multiple functions need to be controlled simultaneously. This enables the autonomy of the locomotion, allowing it to move without any human control and a constant supply of air. The timings of actuation were tuned in order to determine the optimal exchange between actuator durability and robot speed as shown in FIG. 9.

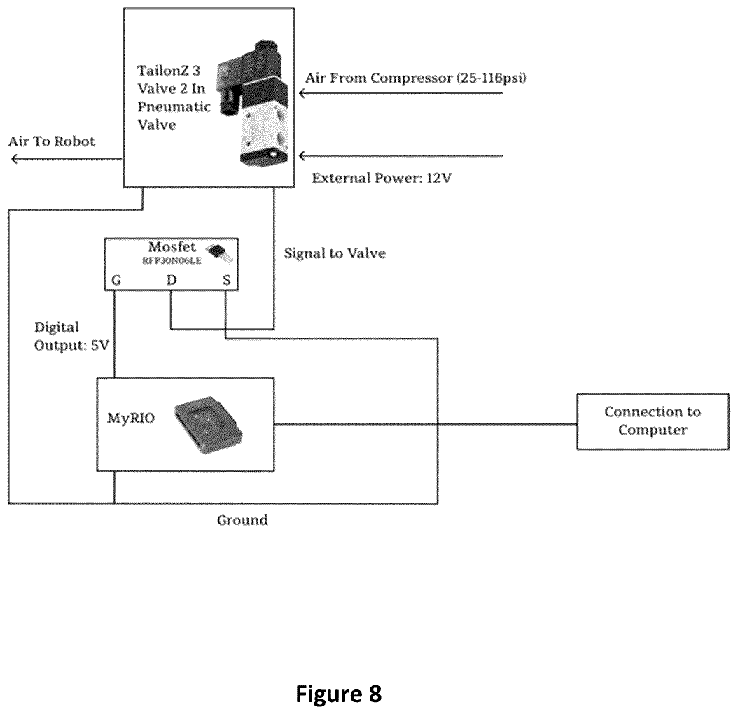

In order to control the airflow to each individual actuator of the robot, pneumatic valves are used. The TailonZ 3-2 pneumatic valve, an electrically actuated solenoid valve, is selected since it supports a wide range of PSI values (25 PSI-116 PSI). FIG. 8 depicts the control diagram of one pneumatic valve. The 12V power to the valve from the external power source is regulated through a MOSFET (part number RFP30N06LE controlled by the MyRIO. The digital output pin of the MyRIO is connected to the gate of the MOSFET, and the presence of a 5V signal opens the valve.

### 4. Overall Locomotion Properties

The robot's locomotion resembles that of an inchworm and is achieved through the staggered actuation of its soft actuators and grippers. Horizontal locomotion is done on horizontal pipe surfaces. To achieve it, the rear feet are first planted. It then extends and plants its front foot. It then releases the rear foot and contracts. Vertical climbing is achieved in a similar fashion. However, more time is given to the feet to adhere to the pipe surfaces to prevent slipping. Deformation is achieved through the individually actuated extensional actuators. To deform vertically, the actuators on the opposite of the intended direction of motion are used. For example, to extend upwards, only the bottom actuators are used. The robot achieves a speed of 15 mm/s on horizontal surfaces, and 9 mm/s on vertical surfaces.

The inchworm-like locomotion is achieved through the subsequent inflation and deflation of the actuators and pouch motors. The sequence of actuation for horizontal locomotion is shown in the timing diagram in FIG. 9. Inflation of the front foot loosens the gripper from the pipe. The extensional actuators then extend and push the front foot forward. The front foot then locks in place with the actuators deflated, and the rear foot opens via inflation. The contractional actuators, combined with the elastic force of the extensional actuators returning to their original position cause the rear foot to be pulled up behind the front foot. The process completes one stride, and it takes 9 seconds. The robot crawls at a speed of 15 mm/s horizontally. This speed is calculated by taking the distance the robot travels in a given amount of time, and then dividing by the time it took to move that distance which gives the average speed reported. Vertical climbing is achieved in a similar fashion, but more time is given to the feet to adhere to prevent slipping. A speed of 9 mm/s is achieved, and this is due to both the extra time given to the grippers and the need to fight gravity when climbing. This speed is calculated in a similar way to the speed of horizontal locomotion. This measurement is taken with the full payload of 417 grams mounted on the robot.

The length of the robot is alterable to increase adaptability to differing pipeline environments.

The deformation of the compliant scissor linkage shown in the CAD diagram in FIG. 1, combined with the soft extensional actuators, allows SPIRo's body to extend and flex. This is done via the actuation of the soft extensional actuators. For general extension of the body. The actuators mounted horizontally on the body of the robot are all extended, causing the scissor linkage to extend forward.

The body is shown to be able to deform up to 60 degrees vertically, as in FIG. 10A and 10B. This is sufficient for the foot to be angled from the horizontal surface, allowing SPIRo to transfer from horizontal to vertical locomotion (FIG. 10C). These cap abilities allow SPIRo to make minor adjustments in heading and perform more complex pipe environments with obstacles such as pipe connectors.

The scissor linkage's deformability, combined with the flexibility of the soft extensional actuator allows the body to extend and flex. This is achieved with the independent actuation of the robot's extensional actuator. For basic forward locomotion, all extensional actuators and then all contractional actuators are extended in sync. However, only select actuators are used for steering and maneuvering.

The robot can accurately maneuver in a variety of pipeline conditions, including those with bends and vertical climbs, as well as shift between these different modes of locomotion.

For vertical maneuvering, only the extensional actuators on the outside of the desired bending direction are used. For instance, for bending upwards, only the extensional actuators on the underside of the robot are used. Similarly, for bending downwards, only the extensional actuators on the top of the robot are used. In FIG. 11, the body is shown to be able to bend 60 degrees vertically in either direction. This is sufficient for transitions between horizontal and vertical surfaces. This degree of deformation is found by determining the location of the foot relative to the starting location in each frame of the video, which is represented by the blue dots in FIG. 11. Trigonometric functions are then used to determine the degree to which the foot has moved.

FIG. 12 shows the flexible body of the system. FIG. 12A is a graph of the deformation of the body over time as measured in degrees. The color of the lines corresponds with the caption of each image below. FIG. 12 B shows the bending of the body in 4 directions: Upwards, Downwards, Left, and Right.

For lateral maneuvering, both the extensional and contractional actuators are used. To turn the robot rightwards, the extensional actuators on the left of the robot are inflated to push the scissor linkage leftwards. The contractional actuators on the right side are also used to compress the right side of the robot which increases the turning angle. As shown in the graph in FIG. 10, the robot is able to turn 40 degrees left or right, which allows the robot to make changes in direction as shown in FIG. 14. This number is achieved in a similar way to the previous deformation measurement. The slight fluctuation in values of left and right deformation can be attributed to the force of the pneumatic tubing on the robot as well as non-linearities within the independent actuators causing different forces.

The inchworm-like locomotion is achieved through the subsequent inflation and deflation of the actuators and pouch motors. The sequence of actuation for horizontal locomotion is shown in the timing diagram in FIG. 9. Inflation of the front foot loosens the gripper from the pipe. The extensional actuators then extend and push the front foot forward. The front foot then locks in place with the actuators deflated, and the rear foot opens via inflation. The contractional actuators, combined with the elastic force of the extensional actuators returning to their original position cause the rear foot to be pulled up behind the front foot. The process completes one stride, and it takes 3 seconds. The robot crawls at a speed of 15 mm/s horizontally. Vertical climbing is achieved in a similar fashion, but more time is given to the feet to adhere to prevent slipping. A speed of 9 mm/s is achieved, and this is due to both the extra time given to the grippers and the need to fight gravity when climbing. The speed is determined by recording the robot's movement over a fixed distance and tracking its position throughout the trial. The starting time is recorded just before the front foot begins its first step, and the ending time is taken when the rear foot completes its final step, bringing the robot to the end of the measured distance.

The soft McKibben artificial muscle actuators allow for the deformation of the scissor linkage. They are fabricated using latex tubing, with a layer of nylon mesh covering the tubing. The nylon mesh compresses around the latex, as it extends, preventing the actuators from deforming laterally rather than forwards. The horizontally mounted actuators extend the linkage forwards, hence the name extensional actuators. The soft actuators on the SPIRo are always inflated with 10 PSI. The deformation of the actuators at 10 PSI is 27.49 mm, as demonstrated in FIG. 13. This is measured as the delta between the actuator's initial uninflated length, and its length at 10 PSI, which is about linear with SPIRo's stride length, which is measured at 27.72 mm using a similar method. The slight difference in the stride length and individual extension length can be accounted for by general non-linearities in SPIRo's body, as well as slight deformation of the TPU scissor structure under load.

The soft McKibben muscle inspired actuators allow for the deformation of the scissor linkage when they inflate and deflate, making them a key part of locomotion. As the actuator extends and the latex expands, the nylon cover around the latex keeps it from expanding horizontally instead of forward as it should.

A camera is used to track the deformation of the actuators. Prior to measuring the distance, the video of the actuator is straightened along the vertical axis to reduce error from bending laterally to the left or right. The actuators are fully inflated at a pressure of 32 PSI, where they have a deformation distance of 40.7 mm for an extensional actuator with a length of 40 mm. The stride length of the robot is 40.2 mm, which is almost linear with the actuator's extension. The slight nonlinearity can be attributed to the general non-linearities in the body, as well as slight deformation of the TPU scissor structure when under the force of the actuators. This is shown in FIG. 15.

The curved magnetic gripper is suitable for gripping curved surfaces, as the grippers curve wrap around the pipe being attached to. FIG. 2 shows an example. The grippers used in this work are designed to conform to a pipe of 14 cm in diameter. The dimensions of the gripper can be interchanged to attach to pipes of varying diameters. The gripper attaches to the pipe surface via a set of 6 neodymium magnets, each with a strength of 4000 gauss. There is a strip of silicone attached under the foot to provide friction along the pipe and prevent the gripper from slipping on low friction surfaces. The silicone is only mounted on the outsides of the grippers so as not to interfere with the sliding of the grippers when the robot is in motion. Each gripper is able to support 317 grams of weight on its own, which was determined by placing calibration masses on a tray hanging from the gripper, as the gripper is attached to a vertical, 90-degree surface. The masses are added onto the tray until the gripper begins to slip. This strength allows one foot to support the entire mass of SPIRo on a vertical surface, which is essential as the warm-like locomotion of SPIRo requires that only one foot is in use for certain periods of time. This also allows SPIRo to carry a payload of up to 157 grams for sensors or thermal cameras.

The pouch motor actuators are used to engage and disengage the magnetic foot. This is required to enable the inchworm-esque locomotion of SPIRo. The magnets are mounted on top of the pouch motors, and when they are inflated, the pouch motors lift the magnets up and away from the surface, breaking the magnetic force of attraction between the magnet and the ferromagnetic pipe as depicted in FIG. 16B. The pouch motors feature an origami inspired design, in which the inside layer of the pouch motor features an extra fold. The fold increases the deformation distance while keeping the size at a minimum, because the fold creases into the inside of the motor rather than out but still gives the motor more distance to expand. The origami inspired pouch motors are used to lift the magnets off of the pipe which disengages the magnetic foot. The magnets are attached to the top of the pouch motors, and they are lifted when the pouch motors inflate. This breaks the attraction between the magnet and pipe and allows the gripper to slide. The deformation of the pouch motors is also dependent on their size. The pouch motor features an origami inspired design, in which the side wall of the pouch features a crease as depicted in FIG. 16. The fold increases the deformation distance while not affecting substantively the size because the fold increases the vertical distance the sidewall can expand. Because the deformation of the pouch motor is dependent on its size, compressing the size via the origami features allows for a more compact size. The deformation of the two designs of pouch motors at two different dimensions was tested. The smaller dimension was 45×85 mm, and the larger was 65×95 mm. Overall, the larger the pouch motor, the greater the expansion distance. This is demonstrated in FIG. 17, which compares the 4 design options. The origami inspired pouch motors expand further than the non-origami inspired alternative. The deformation data is tested by inflating each dimension of pouch motor design to the desired PSI, and then measuring the deformation distance across the center, where the magnets are mounted. The large origami pouch motor had the largest expansion, reaching 19.8 mm. This was followed by the larger non origami design, at 14.8 mm, and the smaller origami design at 13.5 mm.

### 5. Sensor Data Collection

The robot has a payload capacity of 161 grams, which is crucial for accommodating the sensors and apparatus necessary for gas leak detection. Multimodal data of thermal images and gas sensor data was collected to enable more accurate leak detection for SPIRo. Specifically, for this work, multiple sensors are chosen for multimodal data analysis to improve the redundancy and robustness of the leak detection system and mitigate the effects of environmental disturbance. Optical gas imaging (OGI) and gas composition sensors are used. Thermal imaging can be used. Examples of the gas composition sensors are the MQ2 and MQ7 metal oxide sensors. These sensors detect methane and carbon monoxide respectively, as methane is commonly distributed in natural gas pipelines and carbon monoxide is produced when oil is burned. The MQ2 sensor specifically senses for methane with a range of 100 to 10000 parts per million (ppm), while the MQ7 sensor senses for carbon monoxide with a range of 20 to 2000 ppm. These two specific sensors were selected as they detect the two most common chemicals carried in gas pipelines.

Another way to detect gas leaks is through thermal imaging. The gas found in gas pipes is warmer than its surroundings, and in the event of a leak, the gas will cause the environment around a gas pipe to heat up. The thermal camera utilized can detect a temperature range between −40 degrees Fahrenheit to 626 degrees Fahrenheit with a field of view of 46 degrees and a resolution of 206 by 106 pixels. Moreover, the temperature range is adjustable, allowing for increased sensitivity to minor gas leaks. One significant advantage of utilizing a thermal camera is that it can penetrate smoke, mist and dust and work in dark and windy conditions, while simultaneously detecting the heat that is emitted from them, since gas pipelines are often heated to high temperatures.

However, because the thermal camera is mounted on the robot, the thermal images may not be perfectly aligned, causing only parts of the image to reveal a gas leak. Furthermore, the thermal images could be affected by the background environment, leading to sometimes incorrect temperature readings which may indicate a false positive or negative of a gas leak. Therefore, having two types of gas monitoring mechanisms can increase the reliability and redundancy of gas leak detection when one data source is obstructed or unreliable. These sensors are also chosen because they are compact and lightweight.

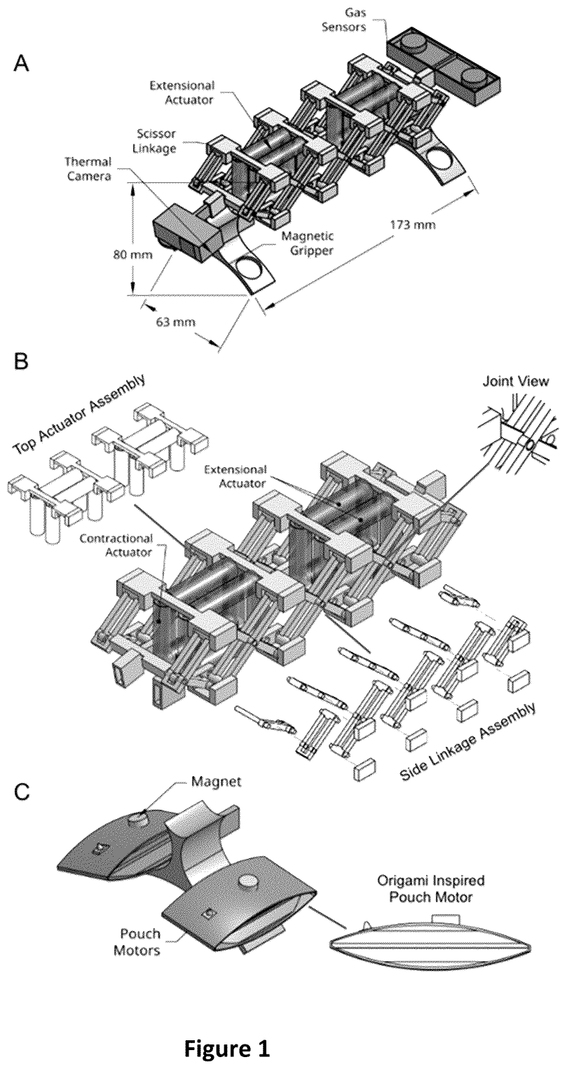

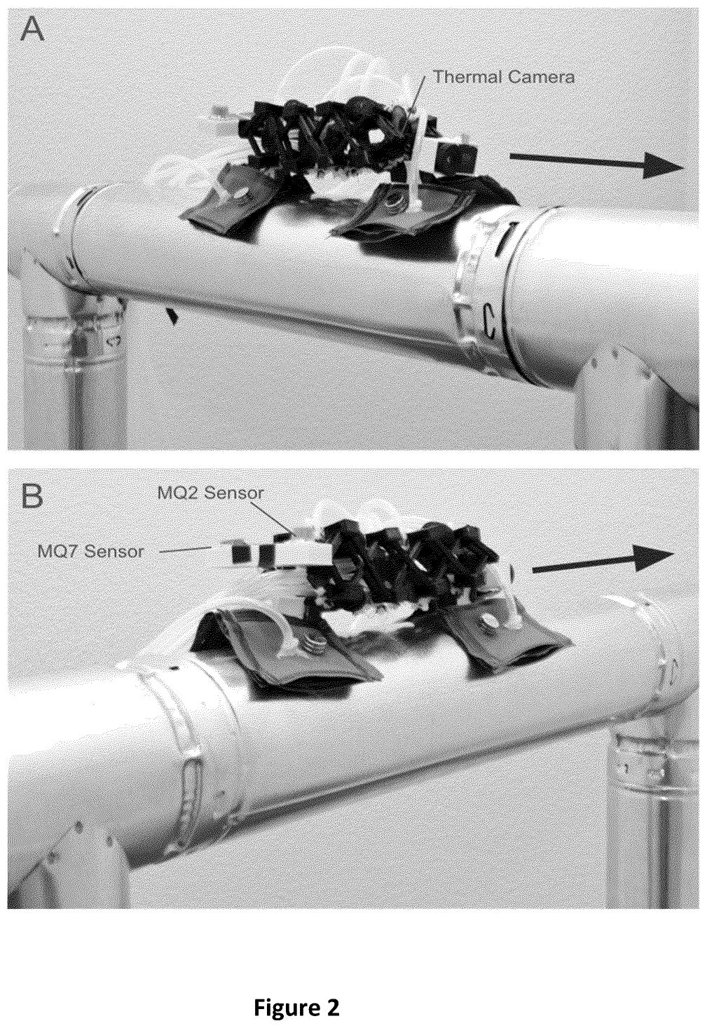

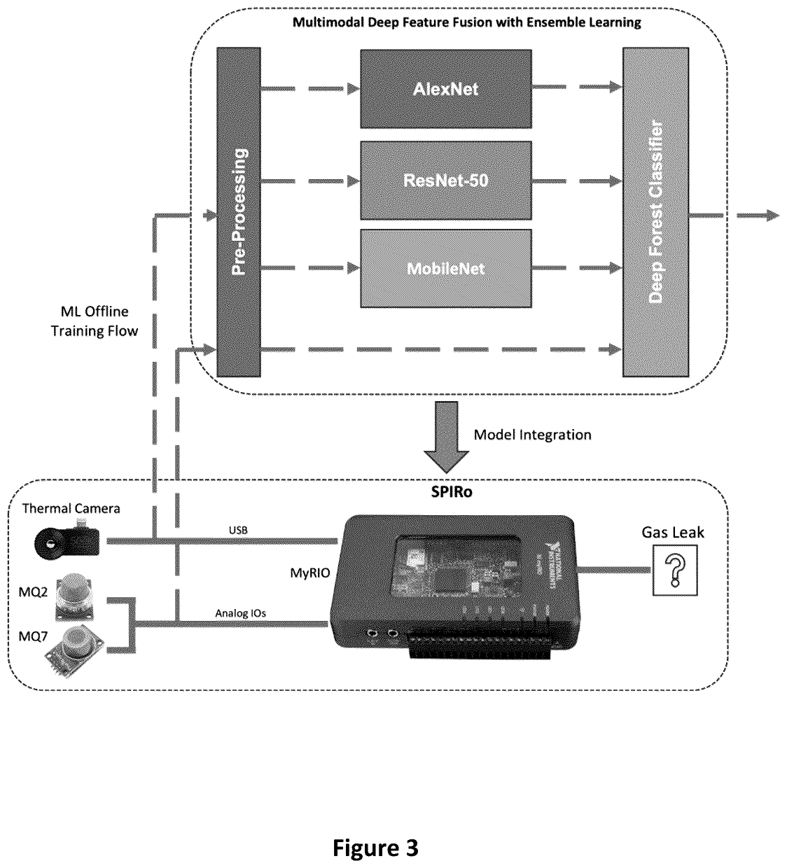

The complete system and integration of the soft robot are shown in FIG. 3. Real time leak detection and data collection is implemented through the MyRIO microcontroller and its WIFI capabilities. Thermal images and gas sensor data are collected at 60 Hz to ensure a constant flow of up-to-date data.

### 6. Framework and Implementation

### 6.1 Algorithm Framework

The SPIRo's movement, sensor data and thermal image acquisition, and gas leak detection are all controlled by the National Instruments MyRIO-1900 microcontroller. The MyRIO microcontroller has a 256 MB memory, a high processing speed of 667 mHz, and most importantly, the ability to collect image data. It can also support the AI and machine learning libraries needed to integrate the trained model for real-time gas leak detection. The MQ2 and MQ7 gas sensors are connected to MyRIO through analog input pins, while the thermal image camera is connected through the dedicated image USB port on the MyRIO. Examples of their output are shown in FIG. 21.

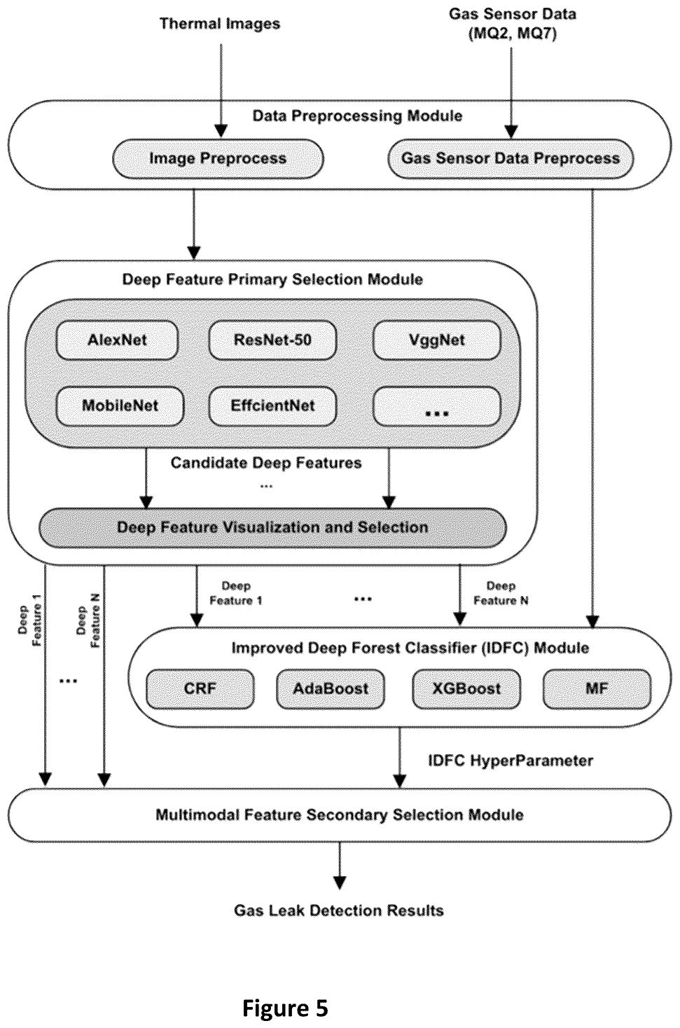

As illustrated in FIG. 5, SPIRo relies on the deep learning model of multimodal fusion through the DFC to fuse sensor and image data in order to accurately detect gas leaks. The complete workflow involves the following steps. First, gas sensor data and thermal image data of the pipeline environment acquired by SPIRo form the offline training dataset. Then, after pre-processing, to extract deep features of the images, the thermal images in the dataset are inputted into three different CNN convolutional layers: the AlexNet, ResNet-50, and MobileNet. Next, the extracted image features fused with the normalized sensor data are passed into the deep forest classifier to perform ensemble learning. Finally, the trained model is integrated into SPIRo's MyRIO microcontroller to achieve real-time detection of the gas leaks.

Deep learning, an extension of machine learning, has been proved successful at detecting gas leaks, but has not yet been integrated into soft robotic systems. FIG. 18 shows that two types of deep learning models are used to analyze two different formats of data. The Convolutional Neural Network (CNN) is employed due to its image processing capabilities. The convolutional layer, which is the distinguishing factor from other types of neural networks, is more suitable for extracting features from the pixels of an image without losing any information. On the other hand, an Artificial Neural Network (ANN) is used because of its ability to easily identify relationships between two datasets. Since multiple gas sensors are used, the ANN helps determine the correlation between the sensor readings and the presence of a gas leak, making it the most accurate option.

FIG. 5 illustrates the proposed multimodal deep feature selection and fusion with improved deep forest classifier ensemble learning architecture. The framework consists of four modules, which are highlighted below.
(1) Data preprocessing module. The data is first pre-processed by normalization based on the same scale to remove bias among input features in different data elements. The thermal images are also unblurred to create a clearer contrast between warmer regions which indicate the presence of a gas leak and cooler regions which do not.

As part of the pre-processing, the images are first resized to a size of 224×224×3, reducing the computational time of the model. To further improve the reliability and accuracy of the model, the images are normalized using the 0-1 normalization method before training. This reduces the effects of outliers and ensures the consistency of data being passed to a machine learning model. Additionally, 0-1 normalization also maintains the differences in colors for thermal images.
(2) Deep feature primary selection module based on visualization and prior knowledge. This module is responsible for developing and identifying the most optimal combination of CNNs for gas leak detection. This is achieved by generating the features of each layer of the CNNs using heatmaps and then visually determining the best combination of the layers to identify the gas leaks in the thermal images.

As mentioned earlier, the convolutional layers of different CNNs are utilized in the model. The AlexNet is selected because it is adaptable to a variety of image variations. The ResNet-50 is chosen due to its ability to “skip connections”, which skip certain layers if they provide inaccurate results, making it efficient. Finally, the MobileNet is chosen because it uses its depth wise convolutional layers to reduce computational intensity while maintaining accuracy. These three convolutional layers work in conjunction with each other to provide three separate feature maps which are then processed by the ensemble learning algorithm. Having three feature maps will ensure that no data is lost in between, ensuring the higher accuracy of the deep learning algorithm by taking advantage of the benefits of each model. Each of these convolutional layers is equipped with a flatten layer to convert the feature maps into a singular array, but they do not have a fully connected layer to reduce computation and training time and memory. The deep forest ensemble learning algorithm is implemented for intermediate fusion. Ensemble learning for the fusion of different modes of data is essential for ensuring accuracy and redundancy even in the harsh conditions of many gas pipes by weighing out the most important and less important inputs.

The design of the deep learning architecture also takes into consideration that it needs to run on the SPIRo system, which is equipped with a less powerful microcontroller. Hence, the model needs to be lightweight and fast. The ResNet-50 and MobileNet are efficient and reduce the number of complex computations necessary. On the other hand, the AlexNet is still extremely powerful at accurately processing images, ensuring a higher accuracy while maintaining efficiency with a relatively low number of layers and parameters. Moreover, the deep forest algorithm requires significantly less training time and computations, so it is chosen to replace traditional fully connected layers. With fewer computations, less memory is required, aiding in the implementation of the model on SPIRo. All the machine learning models will be evaluated with the standard metrics of accuracy, precision, recall, and F1Score.

One of the essential parts of building an accurate and efficient CNN is determining the best convolutional layer for a given application because each model has its specific advantages. Therefore, the effectiveness of the individual convolutional layer is evaluated first. Table 1 summarizes the individual model training parameters.

TABLE 1
Individual Model Training Parameters

| | Learning | | |
|---|---|---|---|
| | Rate | Epochs | Batch Size |
| AlexNet | 0.00001 | 60 | 128 |
| ResNet-50 | 0.0001 | 50 | 80 |
| MobileNet | 0.0001 | 36 | 80 |
| Gas Data (ANN) | 0.01 | 42 | 20 |

To analyze the gas sensor data, an Artificial Neural Network (ANN) is developed and its results are compared to those of the thermal images and fused models.

Table 2 represents the results of the individual models for both the thermal images and gas sensor data. It shows that all models achieved less than 95% accuracy. For thermal images, the AlexNet accuracy is at 94.53%, which is the most accurate among the three models. This is expected as AlexNet is the most versatile at analyzing and processing images. It is adaptable to a wide variety of images, making it the most successful model for image processing. The use of the ‘ReLu’ activation function also greatly improves accuracy and efficiency. This also shows that all deep learning models have a high accuracy, and there is not much difference between them.

TABLE 2
Individual Models Metrics

| | Accuracy | Recall | Precision | F1Score |
|---|---|---|---|---|
| AlexNet | 0.9453 | 0.9385 | 0.9531 | 0.9457 |
| ResNet-50 | 0.9313 | 0.9340 | 0.9281 | 0.9310 |
| MobileNet | 0.9406 | 0.9434 | 0.9375 | 0.9404 |
| Gas Sensor Data (ANN) | 0.9400 | 1.000 | 0.8857 | 0.9393 |

(3) Improved Deep Forest Classifier module based on multimodal features. The output from the above CNNs' layers is applied with different tree-based ensemble estimators to the Deep Forest Classifier to improve layer diversity. The gas sensor data is fed directly into this layer as well.

The impact of ensemble learning with the Deep Forest Classifier (DFC) on training accuracy was evaluated. In these experiments, the effect of different combinations of the convolutional layers on the eventual training performance was also assessed. The different models experimented with are shown in table 3:

TABLE 3
Definition of the Ensemble Models

| | AlexNet | ResNet-50 | MobileNet | Gas Sensor |
|---|---|---|---|---|
| Ensemble_1 | V | | | V |
| Ensemble_2 | | V | | V |
| Ensemble_3 | | | V | V |
| Ensemble_All | V | V | V | V |

In Ensemble models 1, 2 and 3, only one convolutional layer is fused with the sensor data and both features are passed into the DFC, while the Ensemble_All model includes all three convolutional layers as well as the sensor data.

Table 4 summarizes the ensemble models' performance metrics. Overall, the ensemble learning models have superior performance to the individual models discussed above. There is a 1-3% increase in the training accuracy of the ensemble models over the respective individual models. Furthermore, the Ensemble_All model, with its 98.5% accuracy, offers the best performance among all the models experimented in this study.

TABLE 4
Model Training Results for Fusion
Models with 1 CNN and 3 CNNs

| | Accuracy | Precision | Recall | F1Score |
|---|---|---|---|---|
| Ensemble_1 | 0.9752 | 0.9901 | 0.9615 | 0.9756 |
| Ensemble_2 | 0.9660 | 0.9906 | 0.9459 | 0.9677 |
| Ensemble_3 | 0.9500 | 0.9412 | 0.9600 | 0.9505 |
| Ensemble_All | 0.9850 | 0.9912 | 0.9811 | 0.9905 |

The results reinforce the theory that, by integrating different CNN convolutional layers with different strengths, the DFC is able to classify and weigh each model in the training process, improving accuracy.
(4) Multimodal feature secondary selection module based on Accuracy-Size Comprehensive Indicators. Identifying the effects of selecting different combinations of CNNs and their respective features using the Accuracy Size Comprehensive Indicator as depicted in the final section of FIG. 1 as well as the tuning of hyperparameters using an exhaustive grid search on the leak detection accuracy of the proposed leak detection system.

### 6.2 Improved Deep Forest Classifier Module

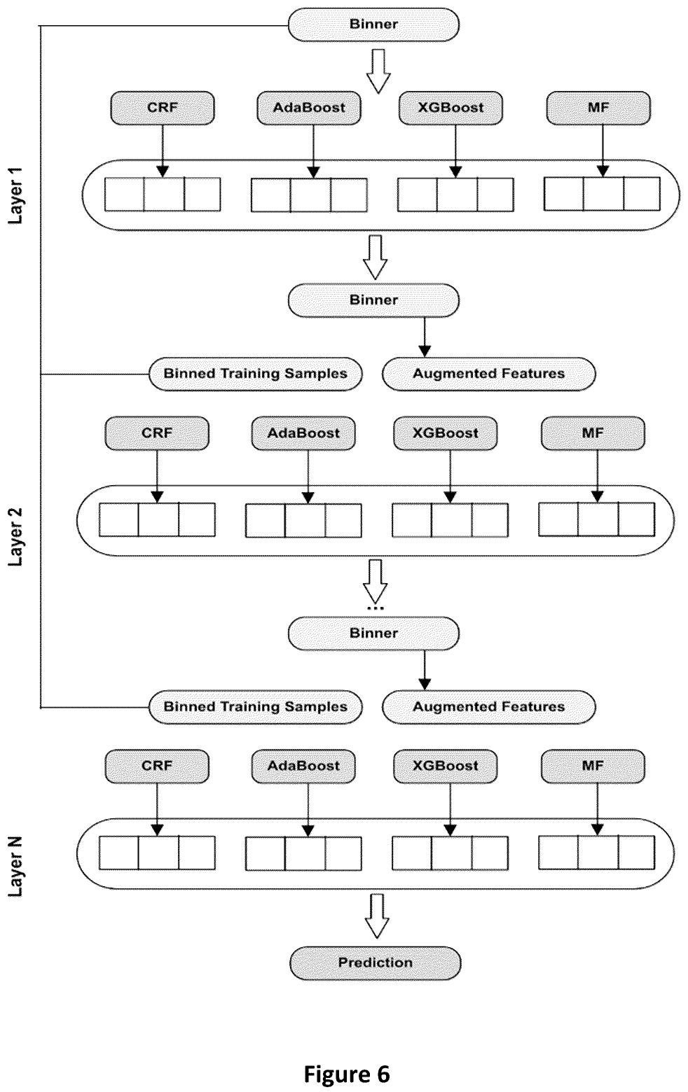

The proposed IDFC architecture is illustrated in FIG. 6. The IDFC algorithm follows a cascade forest architecture, with each layer built on top of the previous one. It represents a deep learning network, but instead of using neurons like in a standard deep neural network, the IDFC employs a more diverse set of base learners. The inputs to the IDFC involve the concatenation of the flattened feature maps from each CNN selected in the deep feature primary selection module and the gas sensor data. The data from the input layer first enters a data binner, which reduces the number of splits that a decision tree needs to consider making. The first layer of the IDFC is built using this binned data. From there, the training data for subsequent layers is created by concatenating the binned predictions from the previous cascade layer with the original training samples. This new layer's performance is then evaluated on the training data using out-of-bag samples from the original dataset. If the added layer performs better than the previous layers, then another layer will be constructed. Otherwise, the IDFC terminates the training process.

To understand the contribution of each model provided for improved accuracy, the DFC weight graph is plotted, as shown in FIG. 19. The MQ2 gas sensor carries the most weight since natural gas is the most common element found in gas leaks. The MQ7 gas sensor also carries significant weight because these traditional gas sensors are the most reliable method of obtaining an accurate measurement. However, the thermal images still carry a total of 25% of the weight in the prediction. This aids in improving the accuracy of the individual gas model from 94% to 98.5%, meaning that without the thermal images, the gas sensors will not be able to detect certain edge cases.

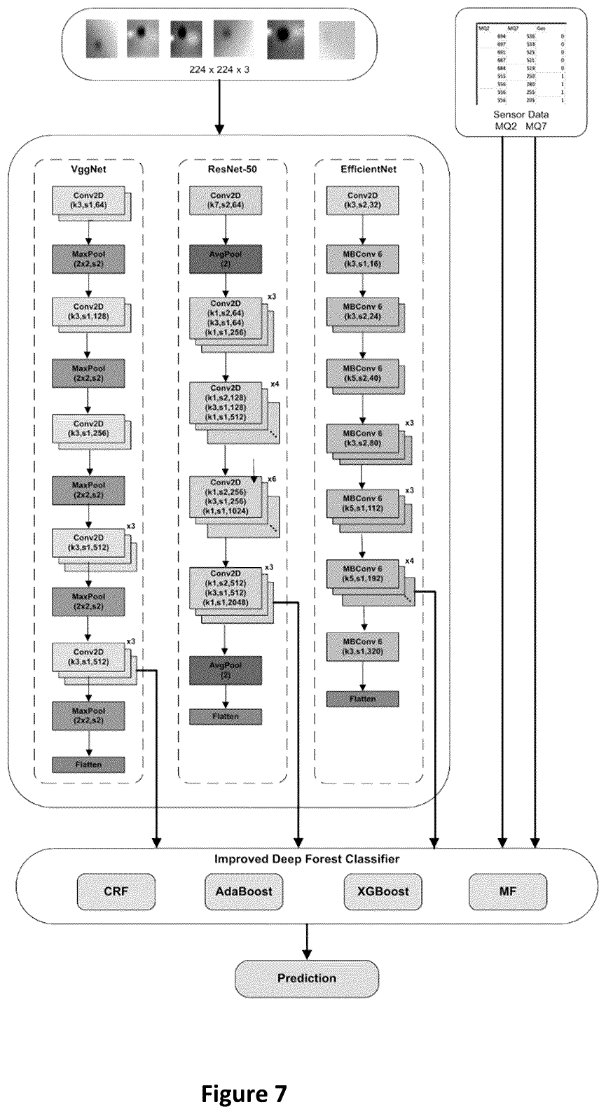

FIG. 7 presents the final architecture of the proposed gas leak detection method. The complete architectures of each CNN are depicted, with arrows indicating the end of each selected convolutional layer. This architecture achieves nearly 99% accuracy on simulated testing data while remaining lightweight enough to be deployable in real-time systems such as soft robots.

### 6.3 Databases Used

For the initial training of the machine learning model, the public MultimodalGasData dataset developed by Narkhede et. al is utilized (https://data.mendeley.com/datasets/zkwgkjkjn9/2). The dataset contains gas sensor values and thermal images for those corresponding values, allowing the first development of the CNN and ANN. Then sensor data and thermal images are collected by SPIRo in a simulated gas leak environment and the machine learning model is evaluated with the data. The gas leaks are simulated by releasing 1000 PPM calibrated methane gas in different locations with different frequency, and a heater is turned on and off accordingly close to the pipe where the calibrated gas is leaked.

The MultiModalGasData dataset developed is divided based on a 3:1:1 ratio for training data, training validation data, and testing data. SPIRo's dataset is solely used for testing.

The MultiModalGasData is used for model development work. It contains 1600 thermal images and their corresponding gas sensor readings of simulated gas leaks as well as 1600 instances of standard no leak situations, which makes it compatible with the dual sensor and thermal imaging setup of SPIRo.

Gas data and thermal images collected by SPIRo in a simulated gas pipeline environment are used for the testing of the proposed model. The dataset contains 200 thermal images and their corresponding gas sensor data readings. The simulated environment was created by releasing trace amounts of methane and carbon monoxide periodically while heating up the surroundings of a pipe. For the first 100 samples, no gas was sprayed. For the next 100 samples, gas was periodically released. FIG. 20 shows samples of the images captured by SPIRo's on-board thermal camera with FIGS. 20A-20C showing no leak situations, FIGS. 20D-20F showing minor gas leaks, and FIGS. 20G-20I showing major gas leaks.

### 6.4 Evaluation Result

The proposed trained model has been implemented on the thermal image and sensor value dataset captured by SPIRo. As shown in Table 5, the testing accuracy for this dataset is 10% lower than that of MultiModalGasData for the Emsemble_All model. This could be due to the following reasons: 1) SPIRo's dataset is closer to real life data hence, there is increased background noise. The signal to noise ratio is worse in SPIRo's dataset, so it is expected the accuracy is lower. 2) The thermal camera and gas sensor could be calibrated better with controlled gas leak calibration. 3) The presence of gas is extremely minimal, causing the gas sensors to read only slightly higher, which may also lead to a faulty prediction. This implies that the data from the field will have significantly more background noise than developed datasets, which will cause a significant decrease in accuracy. The accuracy is currently being improved with better data preprocessing methods and applying image augmentation in training data.

TABLE 5
Individual and Ensemble Models on SPIRo's data

| | Accuracy | Precision | Recall | F1Score |
|---|---|---|---|---|
| AlexNet | 0.7778 | 0.9000 | 0.5625 | 0.6923 |
| ResNet-50 | 0.7368 | 0.8181 | 0.5294 | 0.6429 |
| MobileNet | 0.8108 | 0.8333 | 0.4545 | 0.5882 |
| Gas Data | 0.8390 | 0.7612 | 0.8095 | 0.7846 |
| Hybrid 1 | 0.8409 | 0.7761 | 0.8000 | 0.7879 |
| Hybrid 2 | 0.8352 | 0.7612 | 0.7969 | 0.7786 |
| Hybrid 3 | 0.8239 | 0.7463 | 0.78123 | 0.7634 |
| Ensemble | 0.8807 | 0.8438 | 0.8308 | 0.8370 |

### 6.5 Overall Device and Methods

FIG. 22 is a diagram of a pneumatically soft robotic device to detect gas leak from a pipeline. The pneumatically soft robotic device comprises: a compliant scissor linkage for structure, McKibben artificial muscle actuators for locomotion, origami inspired, magnetic, pouch motor-based grippers to attach to pipes, one or more thermal image sensors and one or more gas sensors for real-time gas composition data and thermal imaging data collection, and a controller with a processor and memory, configured to apply a multimodal deep feature selection and fusion method with a deep forest architecture for real-time leak detection.

FIG. 23 is a flow diagram of a method to detect gas leak from a pipeline by a pneumatically soft robotic device. The method to detect gas leak from a pipeline by a pneumatically soft robotic device, comprises: attaching to a pipe by origami inspired, magnetic, pouch motor-based grippers, moving on the pipe by a compliant scissor linkage and McKibben artificial muscle actuators, collecting real-time gas composition data by one or more gas sensors, collecting real-time thermal imaging data by one or more thermal image sensors and processing the multimodal data by a controller with a processor and memory applying a multimodal deep feature selection and fusion method with a deep forest architecture for real-time leak detection.

In one or more aspects, an AI-based origami-inspired pneumatic soft robot with multidimensional locomotion and multimodal deep feature selection and fusion with an improved Deep Forest Classifier Architecture for real-time gas pipeline leak detection may include additional aspects, such as any single aspect or any combination of aspects described below or in connection with one or more other processes or devices described elsewhere herein.

In a first aspect, a pneumatically soft robotic device to detect gas leak from a pipeline comprises a compliant scissor linkage for structure, McKibben artificial muscle actuators for locomotion, origami inspired, magnetic, pouch motor-based grippers to attach to pipes, one or more thermal image sensors and one or more gas sensors for real-time gas composition data and thermal imaging data collection, and a controller with a processor and memory, configured to apply a multimodal deep feature selection and fusion method with a deep forest architecture for real-time leak detection.

In a second aspect, in combination with the first aspect, the scissor linkage has a flexible number of scissors link with each scissor comprising of extensional actuators placed at the top and bottom.

In a third aspect, in combination with the first aspect or the second aspect, each of the extensional actuators is independently actuated and controlled by the controller.

In a fourth aspect, in combination with one or more of the first aspect through the third aspect, each of the McKibben artificial muscle actuators has an inflatable inner latex tube inside a nylon sleeve which prevents lateral expansion by constraining the latex to direct force longitudinally.

In a fifth aspect, in combination with one or more of the first aspect through the fourth aspect, the side wall of the pouch in the origami inspired, magnetic, pouch motor-based grippers features a crease which increases the deformation distance while not substantively affecting the size.

In a sixth aspect, in combination with one or more of the first aspect through the fifth aspect, the origami inspired, magnetic, pouch motor-based grippers can be interchanged for differing sizes to adapt to different diameter pipes.

In a seventh aspect, in combination with one or more of the first aspect through the sixth aspect, the controller is further configured to extract deep image features using a plurality of convolutional neural networks (CNNs), fuse the extracted image features with the normalized gas sensor data and apply a deep forest classifier to perform ensemble learning.

In an eighth aspect, in combination with one or more of the first aspect through the seventh aspect, the plurality of convolutional neural networks (CNNs) comprises of AlexNet, ResNet-50, MobileNet, or a combination thereof.

In a ninth aspect, in combination with one or more of the first aspect through the eighth aspect, the deep forest classifier classifies and weighs each model in the plurality of convolutional neural networks (CNNs) and sensor data.

In a tenth aspect, in combination with one or more of the first aspect through the ninth aspect, the robotic device in claim 1, wherein the one or more gas sensors are connected to the analog input pins of the controller.

In an eleventh aspect, a method to detect gas leaks from a pipeline by a pneumatically soft robotic device comprises attaching to a pipe by origami inspired, magnetic, pouch motor-based grippers, moving on the pipe by a compliant scissor linkage and McKibben artificial muscle actuators, collecting real-time gas composition data by one or more gas sensors, collecting real-time thermal imaging data by one or more thermal image sensors, and processing the multimodal data by a controller with a processor and memory applying a multimodal deep feature selection and fusion method with a deep forest architecture for real-time leak detection.

In a twelfth aspect, in combination with the eleventh aspect, the scissor linkage has a flexible number of scissors link with each scissor comprising of extensional actuators placed at the top and bottom.

In a thirteenth aspect, in combination with the eleventh or the twelfth aspect, the method further comprises independently actuating and controlling each of the extensional actuators.

In a fourteenth aspect, in combination with one or more of the eleventh aspect through the thirteenth aspect, each of the McKibben artificial muscle actuators has an inflatable inner latex tube inside a nylon sleeve which prevents lateral expansion by constraining the latex to direct force longitudinally.

In a fifteenth aspect, in combination with one or more of the eleventh aspect through the fourteenth aspect, the method further comprises increasing the deformation distance while not substantively affecting the size of the pouch in the origami inspired, magnetic, pouch motor-based grippers.

In a sixteenth aspect, in combination with one or more of the eleventh aspect through the fifteenth aspect, the method further comprises interchanging the origami inspired, magnetic, pouch motor-based grippers for differing sizes to adapt to different diameter pipes.

In a seventeenth aspect, in combination with one or more of the eleventh aspect through the sixteenth aspect, the method further comprises extracting deep image features using a plurality of convolutional neural networks (CNNs), fusing the extracted image features with the normalized gas sensor data and applying a deep forest classifier to perform ensemble learning.

In a eighteenth aspect, in combination with one or more of the eleventh aspect through the seventeenth aspect, the plurality of convolutional neural networks (CNNs) in claim 16 comprise of AlexNet, ResNet-50, MobileNet, or a combination thereof.

In a nineteenth aspect, in combination with one or more of the eleventh aspect through the eighteenth aspect, the method further comprises classifying and weighing each model in the plurality of convolutional neural networks (CNNs) and sensor data by the deep forest classifier.

In a twentieth aspect, means for a pneumatically soft robotic device to detect gas leak from a pipeline, comprise compliant scissor linkage means for structure, means for locomotion by McKibben artificial muscle actuators, means for gripping to pipes by origami inspired, magnetic, pouch motor-based grippers, means for collecting real-time gas composition data by one or more gas sensors, means for collecting real-time thermal imaging data by one or more thermal image sensors, and means for a multimodal deep feature selection and fusion method with a deep forest architecture for real-time leak detection.

As used herein, a phrase referring to “at least one of”' a list of items refers to any combination of those items, including single members. As an example, “at least one of: a, b, or c” is intended to cover: a, b, c, a-b, a-c, b-c, and a-b-c.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single-or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, or, any conventional processor, controller, microcontroller, or state machine. A processor also may be implemented as a combination of computing devices, e.g., a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also may be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium, such as a non-transitory medium. The processes of a method or algorithm disclosed herein may be implemented in a processor-executable software module which may reside on a computer-readable medium. Computer-readable media include both computer storage media and communication media including any medium that may be enabled to transfer a computer program from one place to another. Storage media may be any available media that may be accessed by a computer. By way of example, and not limitation, non-transitory media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium. Disk and disc, as used herein, include compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those having ordinary skill in the art, and the generic principles defined herein may be applied to other implementations without departing from the spirit or scope of this disclosure. Thus, the disclosure is not intended to be limited to the implementations shown herein, but is to be accorded the widest scope consistent with the claims, the principles and the novel features disclosed herein. The word “exemplary” is used exclusively herein, if at all, to mean “serving as an example, instance, or illustration.” Any implementation described herein as “exemplary” is not necessarily to be construed as preferred or advantageous over other implementations.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, other implementations are within the scope of the following claims. In some cases, the actions recited in the claims may be performed in a different order and still achieve desirable results.

It will be understood that unless features in any of the particular described implementations are expressly identified as incompatible with one another or the surrounding context implies that they are mutually exclusive and not readily combinable in a complementary and/or supportive sense, the totality of this disclosure contemplates and envisions that specific features of those complementary implementations may be selectively combined to provide one or more comprehensive, but slightly different, technical solutions. It will therefore be further appreciated that the above description has been given by way of example only and that modifications in detail may be made within the scope of this disclosure.

Various modifications to the implementations described in this disclosure may be readily apparent to those skilled in the art, and the generic principles defined herein may be applied to other implementations without departing from the spirit or scope of this disclosure. Thus, the following claims are not intended to be limited to the implementations shown herein, but are to be accorded the widest scope consistent with this disclosure, the principles and the novel features disclosed herein.

Additionally, certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. Moreover, various ones of the described and illustrated operations can itself include and collectively refer to a number of sub-operations. For example, each of the operations described above can itself involve the execution of a process or algorithm. Furthermore, various ones of the described and illustrated operations can be combined or performed in parallel in some implementations. Similarly, the separation of various system components in the implementations described above should not be understood as requiring such separation in all implementations. As such, other implementations are within the scope of the following claims. In some cases, the actions recited in the claims can be performed in a different order and still achieve desirable results.

1. A pneumatically soft robotic device to detect gas leak from a pipeline, comprising:
a compliant scissor linkage for structure,
McKibben artificial muscle actuators for locomotion,
origami inspired, magnetic, pouch motor-based grippers to attach to pipes,
one or more thermal image sensors and one or more gas sensors for real-time gas composition data and thermal imaging data collection, and
a controller with a processor and memory, configured to apply a multimodal deep feature selection and fusion method with a deep forest architecture for real-time leak detection.

2. The robotic device in claim 1, wherein the scissor linkage has a flexible number of scissors link with each scissor comprising of extensional actuators placed at the top and bottom.

3. The extensional actuators in claim 2 wherein each of the extensional actuators is independently actuated and controlled by the controller.

4. The robotic device in claim 1, wherein each of the McKibben artificial muscle actuators has an inflatable inner latex tube inside a nylon sleeve which prevents lateral expansion by constraining the latex to direct force longitudinally.

5. The robotic device in claim 1, wherein the side wall of the pouch in the origami inspired, magnetic, pouch motor-based grippers features a crease which increases the deformation distance while not substantively affecting the size.

6. The robotic device in claim 1, wherein the origami inspired, magnetic, pouch motor-based grippers can be interchanged for differing sizes to adapt to different diameter pipes.

7. The robotic device in claim 1, wherein the controller is further configured to extract deep image features using a plurality of convolutional neural networks (CNNs), fuse the extracted image features with the normalized gas sensor data and apply a deep forest classifier to perform ensemble learning.

8. The plurality of convolutional neural networks (CNNs) in claim 7 comprise of AlexNet, ResNet-50, MobileNet, or a combination thereof.

9. The deep forest classifier in claim 7 classifies and weighs each model in the plurality of convolutional neural networks (CNNs) and sensor data.

10. The robotic device in claim 1, wherein the one or more gas sensors are connected to the analog input pins of the controller.

11. A method to detect gas leak from a pipeline by a pneumatically soft robotic device, comprising:
attaching to a pipe by origami inspired, magnetic, pouch motor-based grippers,
moving on the pipe by a compliant scissor linkage and McKibben artificial muscle actuators,
collecting real-time gas composition data by one or more gas sensors,
collecting real-time thermal imaging data by one or more thermal image sensors, and
processing the multimodal data by a controller with a processor and memory applying a multimodal deep feature selection and fusion method with a deep forest architecture for real-time leak detection.

12. The method in claim 11, wherein the scissor linkage has a flexible number of scissors link with each scissor comprising of extensional actuators placed at the top and bottom.

13. The method in claim 11, further comprising independently actuating and controlling each of the extensional actuators.

14. The method in claim 11, wherein each of the McKibben artificial muscle actuators has an inflatable inner latex tube inside a nylon sleeve which prevents lateral expansion by constraining the latex to direct force longitudinally.

15. The method in claim 11, further comprising increasing the deformation distance while not substantively affecting the size of the pouch in the origami inspired, magnetic, pouch motor-based grippers.

16. The method in claim 11, further comprising interchanging the origami inspired, magnetic, pouch motor-based grippers for differing sizes to adapt to different diameter pipes.

17. The method in claim 11, further comprising extracting deep image features using a plurality of convolutional neural networks (CNNs), fusing the extracted image features with the normalized gas sensor data and applying a deep forest classifier to perform ensemble learning.

18. The plurality of convolutional neural networks (CNNs) in claim 16 comprise of AlexNet, ResNet-50, MobileNet, or a combination thereof.

19. The method in claim 17, further comprising classifying and weighing each model in the plurality of convolutional neural networks (CNNs) and sensor data by the deep forest classifier.

20. Means for a pneumatically soft robotic device to detect gas leak from a pipeline, comprising:
compliant scissor linkage means for structure,
means for locomotion by McKibben artificial muscle actuators,
means for gripping to pipes by origami inspired, magnetic, pouch motor-based grippers,
means for collecting real-time gas composition data by one or more gas sensors,
means for collecting real-time thermal imaging data by one or more thermal image sensors, and
means for a multimodal deep feature selection and fusion method with a deep forest architecture for real-time leak detection.
